(19) United States
(12) Patent Application Publication
(10) Pub. No.: US 2013/0189557 A1
(43) Pub. Date: Jul. 25, 2013

(54) Cooling Device For A Vehicle Battery And A Vehicle Battery With Such A Cooling Device

(71) Applicant: Roland Haussmann, Wiesloch (DE)

(72) Inventor: Roland Haussmann, Wiesloch (DE)

(73) Assignee: Valeo Klimasysteme GmbH, Bad Rodach (DE)

(21) Appl. No.: 13/813,379

(22) PCT Filed: Jul. 21, 2011
(86) PCT No.: PCT/EP11/62589

§ 371 Date: Apr. 8, 2013

(30) Foreign Application Priority Data
Jul. 30, 2010 (DE) 102010032899.5

(51) Int. Cl. F28F 3/12; H01M 10/50

(52) U.S. Cl. CPC F28F 3/12; H01M 10/5004
USPC 429/120; 165/177; 165/104.11; 165/104.21

(57) ABSTRACT

The invention concerns a cooling device (12) for a vehicle battery, with a cooling floor (18) containing at least one contact surface and especially a flat contact surface (20) for surface contact with a battery cell group (14), in which the cooling floor (18) has at least one U-shaped, bent, single-piece flat pipework (22) with two horizontally oriented legs (24, 26) and a connecting bridge piece (28).

The invention relates to a cooling device for a vehicle battery, specifically a battery for vehicle propulsion, with a cooling floor consisting of at least one contact surface (and especially a flat contact surface) to provide surface contact with a battery cell group. Furthermore, the invention relates to a vehicle battery assembly with at least one such cooling device and at least one battery cell group.

Vehicle batteries of modern motor vehicles, especially electric or hybrid vehicles, demand high capacity and high power density to give the requisite acceleration and range. When operating the vehicle, the vehicle drive battery is discharged as the stored energy is used or charged as energy is input (e.g. during braking). Heat is released during these charging and discharging processes, which can affect the performance and lifespan of the vehicle battery.

Cooling devices are therefore already known from the prior art, which keep the vehicle battery to operating temperatures of 40° C. to 60° C.

Patent US 2009/0142653 A1 for example shows a cooling device in the form of a cooling floor for a battery pack. Because the cooling pipe meanders through the entire cooling floor, the pipe length in this case is extremely long and realizing uniform cooling of the battery pack is correspondingly difficult, depending on the coolant used. In addition, a large-diameter pipe is required in order to achieve the required cooling capacity for the battery pack.

Patent WO 2009/146876 A1 also discloses an apparatus for cooling a vehicle battery. A heat sink with channels for a fluid to flow through is in thermal contact with the electrical storage elements of the vehicle battery. Furthermore, the cooling body/heat sink is made as an extruded profile, thus making the manufacturer of the cooling device simple and inexpensive.

The purpose of the invention is to provide an efficient cooling device for a vehicle battery that lowers the battery temperature to the desired level, minimizes the temperature differences between the individual battery cells and can moreover be manufactured simply and inexpensively.

The subject matter of this invention achieves this aim using a cooling device for a vehicle battery, such a device having a cooling floor with at least one specific flat surface for surface contact with a battery pack, in which the cooling floor consists of at least one single-piece flat pipework, bent at an angle, with two horizontally oriented legs and a connecting bridge piece. Despite the short line length (only a single U-shaped loop), the flat surface of the pipework has a large contact surface with the battery cell group, providing very uniform cooling for the individual battery cells. In addition, the flat pipework allows a high coolant flow for a low built-in height, thereby giving it a high cooling capacity. A further benefit of this cooling device is also the fact that a cooling floor using a bent U-shaped flat pipework is easy and affordable to manufacture and can be assembled onto a battery cell with minimum effort.

The above-mentioned flat pipework is distinguished by the fact that it has a cross-section in which the width of the line is greater than its height. The arrangement of the legs in the heat sink is defined by the bottom surface of the battery cell group, with the flat pipework having its flat side parallel to the bottom surface of the battery cell group.

The flat pipe is preferably bent into a U shape. This means that the legs of the flat pipework are essentially at an angle of 180° to one another, making a compact design of the cooling floor possible.

The two legs of the U-shaped flat pipework are preferably coplanar, specifically with one of the two flat sides of each leg creating the contact surfaces for the battery pack. This construction creates a particularly large contact area between the flat pipework and the battery pack, for just a low overall height of the cooling floor.

In one version of the cooling device, the flat pipework in a transitional area between the connecting bridge piece and the legs is twisted under plastic deformation in such a way that the flat pipework in the bridging piece zone runs essentially upright. The flat pipework in this configuration is said to be “arranged horizontally” if the contact sides and flat sides of the flat pipework are aligned essentially parallel to the contact surface of the cooling floor, or “arranged vertically” if the flat sides of the flat pipework make an angle of at least 45° with the contact area. In particular, the flat pipework at the connecting bridge piece is aligned upright and makes an angle of about 90° with the flat pipework of the legs.

The flat pipework in the transition zone between the connecting bridge piece and the legs can in particular be deformed in such a way that the flat side, which provides the contact area for the leg regions, is facing the legs in the connecting bridge area. This deformation can be realized with little effort during manufacture and results in a very compact cooling loop for the flat pipework.

In another version of the cooling device, the width of the flat pipework is at least twice as great, and preferably five times greater, than the height of the flat pipework. For example, the width of the piping can be about 15 to 50 mm, with the height of the piping being of the order of 1 to 3 mm. For a width-to-height ratio of about 10:1, the flat pipework can be manufactured with little difficultly, keeping the built-in height down and the contact area of the cooling floor against the flat surface of the battery cell group high. Moreover, the requisite coolant flow rates are achieved at this ratio with an acceptable flow resistance.

Preferably, the distance between the central axis of the flat pipework in the leg regions and the central axis of the flat pipework in the connecting bridge region, measured perpendicularly to the contact surfaces, should not exceed half the breadth of the flat pipework. This allows the vertically oriented connecting piece to be adjusted to a position that is perpendicular to the contact surfaces, according to the individual spaces into which it is to be built, while at the same time avoiding excessive bending and material stresses on the flat pipework.

In a further embodiment of the cooling device, the flat pipework has several coolant channels distributed across its width.

In this case, all the coolant channels are preferably arranged across the height of the flat pipework essentially in a single plane, preferably centrally. A construction such as this for the flat pipework is technologically easy to make and moreover makes highly efficient cooling of the battery cell group possible for just a low overall height of the cooling floor.

The cross-sectional width of the coolant channels can then be greater than or equal to the cross-sectional height of the coolant channels. This choice for the coolant channel cross-sections also gives a particularly good cooled contact area for a low built-in height of the flat pipework and the cooling floor. Rounded, and in particular circular, cross-sections for the coolant channels have proved to be particularly advantageous.

The flat pipework at the connecting piece should preferably have a minimal radius of curvature, corresponding to one to three times the height of the flat pipework. By using a minimum radius of curvature at this point, sufficient flow through the curved coolant channels is ensured on the one hand, and a compact structure for the cooling floor is made possible on the other.

In particular, the flat pipework can have multiple coolant channels, with the coolant inlet designed as a distributor to distribute the incoming coolant among the coolant channels. This distributor allows the coolant to be distributed evenly with little effort, thereby achieving a very homogenous cooling effect for the battery cell group, i.e. cooling with a small spread of temperatures over the individual battery cells within the battery pack.

Particularly preferable is having the flat pipework define an evaporator, in which the liquid part of a refrigerant used as the coolant is at least partly vaporized.

In another embodiment of the cooling device, the cooling floor has a least two U-shaped bent flat piping sections, arranged next to one another in such a way that all the legs point in the same direction and the orientations of the flat sides, which define the contact surfaces for a battery cell group, are essentially coplanar. Using at least two U-shaped flat pipeworks allows the width of the flat pipeworks to be reduced, which is beneficial for the deformations of the flat pipeworks during production.

In this version, the coolant inlets of the two U-shaped bent pipework sections are connected together and the two coolant outlets are connected together via a distributor and collector apparatus, in which the distributor and collector apparatus defines precisely one coolant inlet connector and one coolant outlet connector. This distributor and collector apparatus plus the design of the coolant inlets as a distributor allows the coolant to be distributed between the two flat pipeworks and additionally allows the coolant to be distributed within any one flat pipework, without increasing the effort needed to include a coolant circuit in the cooling floor.

Alternatively, a distributor device and a collector device can be separate components, allowing the flat pipeworks to be connected to a coolant circuit.

In particular, a throttle valve can be provided between the coolant inlet connector and each of the coolant inlets. The throttle cross-sections are for example in a range of 5 to 20 mm2 and ensure the desired distribution of the coolant to the coolant inlets in the two flat pipework sections.

The invention also concerns a vehicle battery assembly with at least one cooling device as described above plus at least one battery cell group, in which each battery cell group is assigned to exactly one cooling device. As a result of this arrangement, a modular assembly can easily be produced in which the individual battery cell groups with their own dedicated cooling devices can be placed individually in the space available for building them in.

In a particularly preferable variant, the contact surfaces of the cooling floor, as defined by the flat pipework, cover approximately 30% to 60% of the underside of the battery cell group facing the cooling floor. Due to the even distribution of the coolant plus the efficient cooling process for the battery cell group provided by the flat pipework, having the contact surfaces of the flat pipework covering only roughly half the underside of the battery cell group is sufficient to keep the battery cell groups within the desired temperature range of preferably about 40° C. to 60° C. The construction of the cooling floor is made correspondingly easier, reducing the manufacturing costs of the cooling device beneficially.

Other features and advantages of the invention will become apparent from the following descriptions of preferred variants, with reference to the drawings. These drawings show:

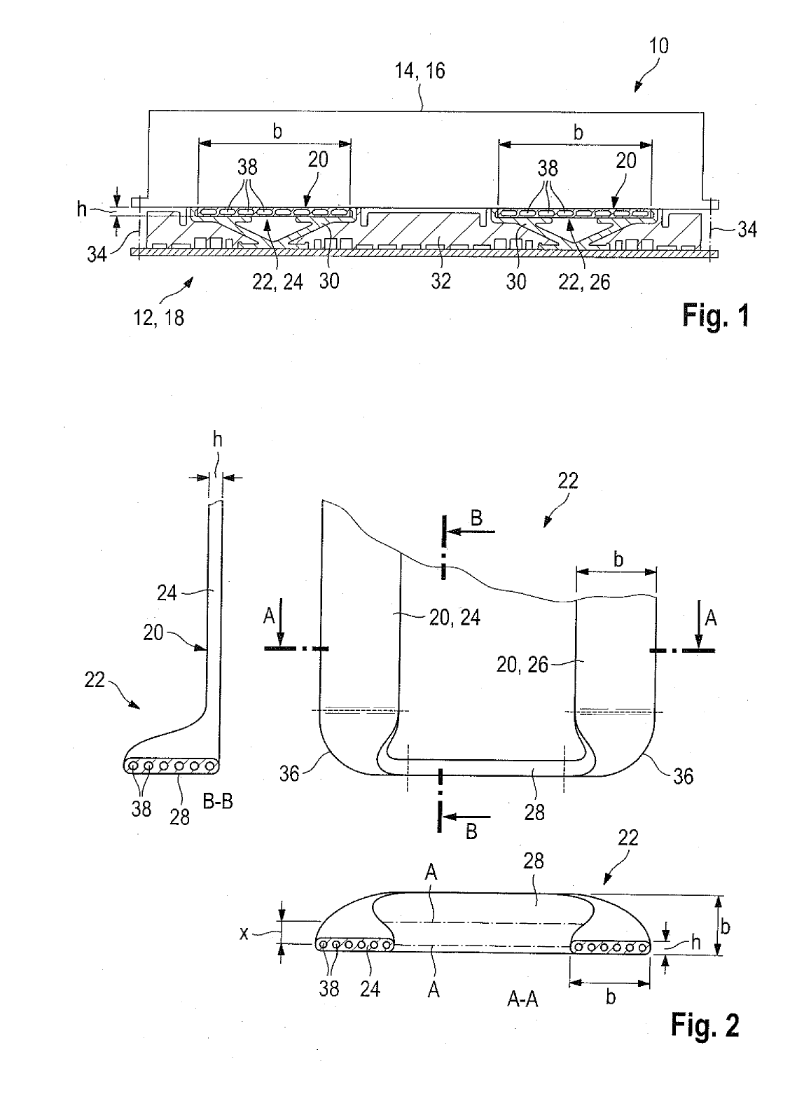

In FIG. 1, a schematic cross-section through a vehicle battery group according to the invention with a cooling device according to the invention;

In FIG. 2, a top view and two sections of a U-shaped bent flat pipework of a cooling device according to the invention;

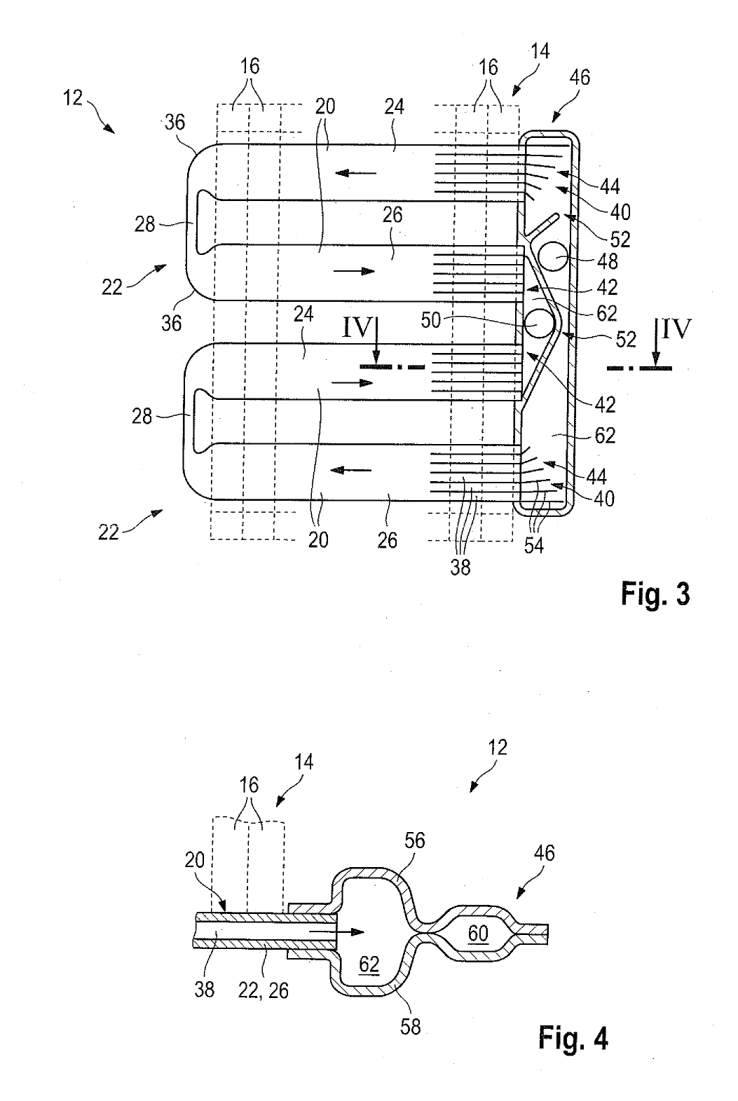

In FIG. 3, a schematic diagram of a cooling device according to the invention, with two connected U-shaped flat pipeworks; and

In FIG. 4, a section IV-IV through a cooling device according to the invention, as per FIG. 3.

FIG. 1 shows a section through a vehicle battery assembly 10 with a cooling device 12 and a battery cell group 14, in which each battery cell group 14 is assigned to precisely one cooling device 12.

The battery cell group 14 is shown as a prefabricated unit made of several battery cells 16 (cf. FIG. 3 also), in which the battery cells 16 can for example be lithium ion cells, supercapacitors, fuel cells, conventional accumulators or combinations of such elements. For example, six to fourteen lithium ion battery cells 16 can define a prefabricated battery cell group 14, which can also be called a battery block or battery pack.

Depending on performance requirements, an appropriate number of battery cell groups 14 are connected together to create a vehicle battery for a motor vehicle, particularly an electric or hybrid vehicle. As precisely one cooling device 12 is assigned to the individual battery cell groups 14, each cooling device 12 plus its associated battery cell group 14 can be positioned relatively freely in order to make the best possible use of the space available for building it in and then connected to a cooling circuit. This cooling circuit can either be a separate cooling circuit, or it could be the cooling circuit of the vehicle's air-conditioning system. The coolants used for this cooling circuit could be either coolant liquids such as water, glycol or water/glycol mixtures, or they could be phase-changing refrigerants, particularly based on carbon dioxide. When refrigerants are used that have both a liquid and a gaseous phase, the cooling device 12 is designed as a refrigerant evaporator, in which a liquid part of the incoming refrigerant is at least partially vaporized.

When the cooling device 12 is operating with a refrigerant, an extremely homogenous temperature distribution is achieved within the battery cell group 14, thanks to the virtually constant evaporation temperature. In addition, there is the benefit that the cooling device 12 in this case can easily be combined with a conventional vehicle air-conditioning unit.

The cooling device 12 according to FIG. 1 includes a cooling floor 18 with a flat contact surface 20 for surface contact with the battery cell group 14, specifically for contact with each individual battery cell 16 of the battery cell group 14.

The cooling floor 18 in FIG. 1 has a U-shaped, bent single-piece flat pipework 22 with two horizontally arranged legs 24 and 26, plus a connecting piece 28 (see also FIG. 2).

In the example variant according to FIG. 1, the flat pipework 22 is placed on flexible supporting elements 30 of the cooling floor 18. The remaining spaces in the cooling floor 18 are at least partially filled in with an elastic plastic foam 32, the material and shape of which also determine the desired contact pressure of the cooling device 12. The cooling floor 18 can for example be elastically compressed by the fastenings 34 shown in FIG. 1, thus being pre-stressed up against the battery cell group 14. This pre-tensioning makes the flexibly designed flat pipework 22 of a cooling floor 18 fit up nicely against the underside of the battery cell group 14 so that excellent thermal transfer is guaranteed.

As a result of the construction of the vehicle battery assembly 10, the cooling capacity of the cooling device 12 is generally already sufficient if it covers 30% to 60% of the contact surface 20 of the cooling floor 18, as defined by the flat pipework, that faces the underside of the battery cell group 14.

The two legs 24 and 26 of the flat pipework 22 are in a coplanar configuration, as shown in FIG. 1, while one of the flat sides of each of the legs 24 and 26 provides the cooled contact surface 20 for the battery cell group 14. The term contact surface 20 shall hereinafter only be understood to mean the flat surface of the flat pipework that is in contact with the battery cells 16 of the battery cell group 14, even where other parts of the cooling floor 18—for example the support elements 30 or the plastic foam 32—comprise further points of contact with the battery cell group 14.

FIG. 2 shows a top view plus two sections through the U-shaped, bent flat pipework 22 as a detailed schematic diagram. This makes clear that the flat pipework 22 in a transitional area 63 between the preferably linear connecting bridge piece 28 and the legs 24 and 26 is twisted under plastic deformation in such a way that the flat pipework 22 at the bridging piece 28 runs essentially vertically. This therefore means that the flat sides of the flat pipework 22 are essentially parallel to the contact surface 20 (“horizontal”) at the legs 24 and 26, and essentially perpendicular to the contact surface 20 (“vertical”) at the connecting bridge piece. In other words, the flat sides of the flat pipework 22 at the connecting piece 28 are upright, i.e. at an angle of about 90° to the flat sides of the flat pipework 22 at the legs 24 and 26.

The deformation of the flat pipework 22 in the transitional region 36 is such that the same flat side that defines the contact surface 20 at the legs 24 and 26 is facing the legs 24 and 26 at the connecting piece 28.

The smaller the radius of curvature chosen for the deformed transitional areas 36 of the flat pipework 22, the more compact the design of the cooling device 12 can be. At the same time, a radius must not be used that is less than the minimum radius of curvature, corresponding to about one to three times the height h of the flat pipework 22, ensuring that the coolant flow in the flat pipework 22 is not impeded too much.

The flat pipework can for example be produced as an extruded aluminum profile. In order to avoid excessive material stresses while deforming the flat pipework 22, the distance x between the central axis A of the flat pipework 22 at the legs 24 and 26, and the central axis A of the flat pipework at the connecting piece 28, measured perpendicularly to the contact surface 20, must not be greater than half the width b of the flat pipework 22. Consequently, the flat pipework 22 in one variant in particular is symmetrically deformed so that the central axis A of the flat pipework 22 at the legs 24 and 26 plus the central axis A of the flat pipework 22 at the connecting piece 28 define a plane that is parallel to the contact surface 20. In another advantageous variant (cf. FIG. 2), the flat pipework 22 is deformed in such a way that the flat pipework at the legs 24 and 26 and at the connecting piece 28 are essentially flush against a top or bottom side and the leg and bridge sections along the central axis A, measured perpendicularly to the contact surface 20, have a separation x=1/2 (b−h).

The flat pipework 22 has a breadth b that is at least twice as great, and preferably at least five times as great, as the height h of the flat pipework. Typically, the breadth b will be of the order of 15 to 75 mm and the height h will be of the order of 1 to 4 mm. A preferred compromise between the greatest possible contact surface area 20, the smallest possible overall height of the flat pipework 22 or the cooling floor 18 and an acceptable flow resistance and manufacturing effort for the flat pipework 22 gives a ratio for the sides of h:b≈1:10.

As can be seen in FIGS. 1 and 2, the flat pipework 22 has several coolant channels 38 distributed across its breadth b. The coolant channels 38 are aligned essentially centrally over the height h of the flat pipework 22. This allows the flat pipework 22 to be manufactured easily as well as providing a large contact surface 20 for a low overall height. The channels 38 extend over the entire length of the U-shaped flat pipework 22.

There is also a positive effect on the ratio between the cooled contact surface 20 and the height if the cross-sectional width of the coolant channel 38 is greater than or equal to the cross-sectional height of the coolant channel 38. The coolant channels in FIG. 1 for example have a horizontal, oval cross-section; conversely, according to FIG. 2, coolant channels with a circular cross-section are indicated as an alternative.

FIG. 3 shows a schematic diagram of the cooling device 12, according to yet another embodiment. The cooling floor 18 here has two U-shaped bent flat pipeworks 22, arranged up against each other in such a way that all the legs 24 and 26 point in the same direction and the flat sides that define the contact surfaces for the battery cell groups 14 are in a basically coplanar configuration. In this design of the cooling device 12, the cross-section of the flat pipework 22—in particular its breadth b—can be significantly reduced, or more specifically halved, which makes the flat pipework 22 in the transitional region 36 easier to deform and means that it disrupts the vertically aligned connecting piece 28 less. The width b in this variant should preferably be about 15 to 25 mm and the height h about 2 to 4 mm.

A free end 40 of one of the legs 24 of the flat pipework 22 defines a coolant inlet and a free end 42 of the other leg 26 of the flat pipework 22 defines a coolant outlet. In the case where the flat pipework 22 has multiple coolant channels 38, the coolant inlet is designed as a distributor 44 that distributes the incoming coolant across the individual coolant channels 38. Particularly when a two-phase refrigerant is used, it is very important—if a homogenous cooling capacity is to be obtained across the contact surfaces 20—that each coolant channel 38 of the flat pipework 22 gets an equal proportion of refrigerant in the gaseous and liquid phases as far as possible, so that the whole flat pipework 22 can function as a homogenous evaporator.

In the embodiment shown in FIG. 3, the two U-shaped, bent flat pipeworks 22 each have a coolant inlet at a free end 40 of one leg 24 and each have a coolant outlet at a free end 42 of the other leg 26. To ensure that this variant of the cooling device 12, with two U-shaped bent single-piece flat pipeworks 22, can be connected up easily to a cooling circuit, the coolant inlets of the two U-shaped bent pipeworks 22 are connected together, as are the two coolant outlets, via a distributor and collector apparatus 46, in which the distributor and collector apparatus 46 has exactly one coolant inlet connector 48 and exactly one coolant outlet connector 50.

A throttle valve 52 with a throttle cross-section in the range 5 to 25 mm2 is placed between the coolant inlet connector 48 and each of the two coolant inlets. These chokes 52 ensure the desired (specifically: equal) distribution of the coolant to the two coolant inlets of the U-shaped flat pipeworks 22. The coolant inlets can then be designed as distributors 44, exactly as shown in the variants in FIGS. 1 and 2, thereby again ensuring equal distribution of the coolant into the individual coolant channels 38. The distributor 44 is indicated schematically in FIG. 3 by the guide plates 54 at the free end 40 of the leg 24.

FIG. 4 shows a section IV-IV taken through a coolant device 12 according to FIG. 3. It is clear here that the distributor and collector apparatus 46 is composed of two parts, an upper part 56 and a lower part 58. At one of the sides between the upper part 56 and the lower part 58, facing the free ends 40 and 42 of the legs 24 and 26, a slot is provided into which the said free ends 40 and 42 of the flat pipework 22 can be inserted. At an opposite end of the distributor and collector apparatus 46, roughly centrally, the upper part 56 and lower part 58 are connected tightly together in order to create an inflow chamber 60 and an outflow chamber 62. Alternatively, a one-piece variant of the distributor and collector apparatus could obviously be envisaged.

1. A cooling device for a vehicle battery, with a cooling floor with at least one contact surface for surface contact with a battery cell group in which the cooling floor contains at least one single-piece flat pipework that is bent at an angle, with two horizontally oriented legs and a connecting bridge piece.

2. A cooling device in accordance with claim 1, wherein the single-piece flat pipework is bent into a U shape.

3. A cooling device in accordance with claim 1, wherein the configuration of both legs is coplanar.

4. A cooling device in accordance with claim 1, wherein the flat pipework in a transitional area between the connecting bridge piece and the legs is twisted under plastic deformation in such a way that the flat pipework in the bridging piece zone runs essentially upright.

5. A cooling device in accordance with claim 4, wherein the flat side which defines the contact surface at the legs is facing the legs in the connecting bridge area.

6. A cooling device in accordance with claim 1, wherein the breadth (b) of the flat pipework is at least twice as great as the height (h) of the flat pipework.

7. A cooling device in accordance with claim 1, wherein the distance (x) between the central axis (A) of the flat pipework in the leg regions and the central axis (A) of the flat pipework in the connecting bridge region, measured perpendicularly to the contact surfaces, should not exceed half the breadth (b) of the flat pipework.

8. A cooling device in accordance with claim 1, wherein the flat pipework has several coolant channels distributed across its breadth (b).

9. A cooling device in accordance with claim 8, wherein all the coolant channels (38) are arranged across the height (h) of the flat pipework essentially in a single plane.

10. A cooling device in accordance with claim 8, wherein the cross-sectional width of the coolant channels is greater than or equal to the cross-sectional height of the coolant channels.

11. A cooling device in accordance with claim 1, wherein the flat pipework at the connecting piece has a minimal radius of curvature, corresponding to one to three times the height (h) of the flat pipework.

12. A cooling device in accordance with claim 1, wherein the flat pipework has multiple coolant channels, with a coolant inlet designed as a distributor to distribute the incoming coolant among the coolant channels.

13. A cooling device in accordance with claim 1, wherein the flat pipework defines an evaporator, in which the liquid part of a refrigerant used as the coolant is at least partly vaporized.

14. A cooling device in accordance with claim 1, wherein the cooling floor has a least two U-shaped bent flat piping sections, arranged next to one another in such a way that all the legs point in the same direction, and the orientations of the flat sides, which define the contact surfaces for a battery cell group, are essentially coplanar.

15. A cooling device in accordance with claim 14, wherein the coolant inlets of the two U-shaped bent flat piping sections are connected together, and the two coolant outlets are connected together via a distributor and collector apparatus, whereby the distributor and collector apparatus defines exactly one coolant inlet connection and exactly one coolant outlet connection.

16. A cooling device in accordance with claim 14, wherein a throttle valve is provided between the coolant inlet connection and each of the coolant inlets.

17. A vehicle battery assembly with at least one cooling device in accordance with claim 1, plus at least one battery cell group, in which each battery cell group is assigned to precisely one cooling device.

18. A vehicle battery assembly in accordance with claim 17, wherein the contact surfaces of the cooling floor, as defined by the flat pipework, cover about 30% to 60% of the underside of the battery cell group facing the cooling floor.

19. A cooling device in accordance with claim 1, wherein the configuration of both legs is coplanar, and wherein the two flat sides of the legs define the contact surface for a battery cell group.
